(19) United States
(12) Patent Application Publication
(10) Pub. No.: US 2016/0355902 A1
(43) Pub. Date: Dec. 8, 2016

(54) WELDING METHOD AND SYSTEM

(71) Applicant: GM GLOBAL TECHNOLOGY OPERATIONS LLC, Detroit, MI (US)

(72) Inventors: David Yang, Shanghai (CN); Jing Zhang, Shanghai (CN); Li Sun, Shanghai (CN); Blair E. Carlson, Ann Arbor, MI (US)

(73) Assignee: GM GLOBAL TECHNOLOGY OPERATIONS LLC, Detroit, MI (US)

(21) Appl. No.: 15/101,613

(22) PCT Filed: Jan. 20, 2014
(86) PCT No.: PCT/CN2014/070914

§ 371 Date: Jun. 3, 2016

(51) Int. Cl. C21D 9/50; B23K 11/16; B23K 11/11; C21D 11/00; B23K 26/32; B23K 20/10; B23K 20/22; B23K 9/23; B23K 26/14

(52) U.S. Cl. CPC C21D 9/505; B23K 9/23; B23K 11/16; B23K 11/115; B23K 26/1429; B23K 26/32; B23K 20/10; B23K 20/22; C21D 11/005; B23K 2203/04

(57) ABSTRACT

A welding method includes the following steps: (a) determining a martensite tempering temperature of the at least two workpieces based, at least in part, on the chemical composition and microstructure of the woworkpieces; (b) applying sufficient energy to the workpieces to melt the workpieces at a target location, thereby creating a weld pool; (c) determining, via the control module, a target temperature and cooling range of a coolant and cooling range based, at least in part, on the martensite tempering temperature and HAZ width; and (d) cooling the first and second workpieces with the coolant such that a temperature of the workpieces at heat-affected zones is controlled below the martensite tempering temperature in order to minimize softening at the heat-affected zones. The present invention also relates to a welding system for minimizing HAZ softening.

### TECHNICAL FIELD

The present disclosure relates to a welding method and system.

### BACKGROUND

Welding is a process that joins materials, usually metals, by causing coalescence. This is often done by melting the workpieces to form a pool of molten material (the weld pool) that cools to become a strong joint, with pressure sometimes used in conjunction with heat, or by itself, to produce the weld. As a non-limiting example, a laser beam may be applied between two metal workpieces, generating heat within the workpieces. The workpieces are wholly or partly made of a base material, such as steel. A molten pool is created where the temperature is greater than the melting point of the base materials subjected to heat. Sometimes, a filler material is added to change the composition of the welds. Next, the weld pool cools and becomes a weld joint.

### SUMMARY

Many different energy sources can be used for welding, including laser, electric arc, electron beam, etc. During welding, energy is applied to at least two workpieces using a suitable energy source in order to generate heat at an interference between the two workpieces. As a non-limiting example, during laser welding, the laser welding head directs energy to a target location at an interference between the two workpieces. As a result, the base material of the workpieces at the target location melts (sometimes along with the filler material), thereby forming a weld pool. The area of the base material around the weld pool, which is not melted, is also affected by the heat generated by the energy applied with the welding head and is therefore referred to as the heat-affected zone (HAZ). The heat in the HAZ can change the microstructure of the base material, thereby changing the mechanical properties of the base material at the HAZ. The HAZ thus refers to an area of the base material that is not melted and has had its microstructure and properties altered by welding. In most cases the effect of welding on HAZ can be detrimental—depending on the base materials and the heat input of the welding process. For example, HAZ of high strength steels is often softened after welding. As a consequence, the hardness of the base material at the HAZ decreases in relation to the hardness of the base material. The extent and magnitude of softening depends primarily on the base material, and the amount and concentration of heat input by the welding thermal process. It is therefore useful to control the thermal process at the HAZ in order to minimize HAZ softening.

A welding method has been developed to minimize HAZ softening by increased cooling speed in HAZ with an external cooling unit compared to the normal welding conditions. The normal welding conditions are referred to that where welds are naturally cooled to room temperature. In an embodiment, the welding method includes the following steps: (a) determining, via a control module, martensite tempering temperature the temperature of martensite tempering (i.e., the martensite tempering temperature), which is one main reason for HAZ based, at least in part, on the chemical composition and microstructure of the base material (e.g. metail) of the first and second workpieces; (b) applying sufficient energy to the workpieces to melt the workpieces at a target location, thereby creating a weld pool; (c) determining, via the control module, a target temperature and cooling range of a coolant based, at least in part, on the martensite tempering temperature and HAZ width; and (d) cooling the workpieces such that the temperature of the workpieces at the HAZs does not reach the martensite tempering temperature in order to minimize softening at the HAZs. Each HAZ is an area of the workpieces around the weld pool subjected to heat stemming from the energy applied to the workpieces at the target location. The term “martensite tempering temperature” refers to the temperature in which tempered martensite is formed in the base material.

The present disclosure also relates to a welding system for minimizing HAZ softening. In an embodiment, the welding system includes an energy source configured to supply energy and a welding head coupled to the energy source. The welding head is configured to direct sufficient energy to at least two workpieces to melt the workpieces at a target location in order to create a weld pool. The welding system further includes a control module programmed to execute the following instructions: (a) determine a martensite tempering temperature of the workpieces based, at least in part, on the chemical composition and microstructure of the base material; and (b) determine a target temperature and cooling range of a coolant based, at least in part, on the martensite tempering temperature and HAZ width. The welding system further includes a cooling system configured to carry the coolant ith the suitable cooling extent and magnitude to cool the workpieces such that a temperature of the workpieces at the HAZs does not reach the martensite tempering temperature in order to minimize softening at HAZs, such that the martensite tempering temperature and its holding time at HAZs of the workpiece are reduced and shortened by enhanced cooling rate from the external strengthening cooling.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagram of a welding system in accordance with an embodiment of the present disclosure;

FIG. 2A is a schematic top view of two workpieces joined by a butt joint;

FIG. 2B is a schematic side view of two workpieces joined by a butt joint;

FIG. 2C is a schematic top view of two workpieces joined by a lap joint;

FIG. 2D is a schematic side view of two workpieces joined by a lap joint;

FIG. 2E is a schematic side view of three workpieces joined by a lap joint;

FIG. 3 is a flowchart illustrating a welding method in according with an embodiment of the present disclosure; and

FIG. 4 is a graph illustrating hardness test results of a welding joint using the welding method of FIG. 3;

FIG. 5 is graph similar to the graph of FIG. 4, but it shows the results of hardness tests for 6061 aluminum alloy;

FIG. 6 is a schematic diagram of a welding system in accordance with another embodiment of the present disclosure, wherein the welding system includes a conduit;

FIG. 7 is a schematic diagram of the conduit of the welding system shown in FIG. 6;

FIG. 8 is a schematic diagram of a welding system in accordance with another embodiment of the present disclosure; and

FIG. 9 is a schematic diagram of a welding system in accordance with another embodiment of the present disclosure.

### DETAILED DESCRIPTION

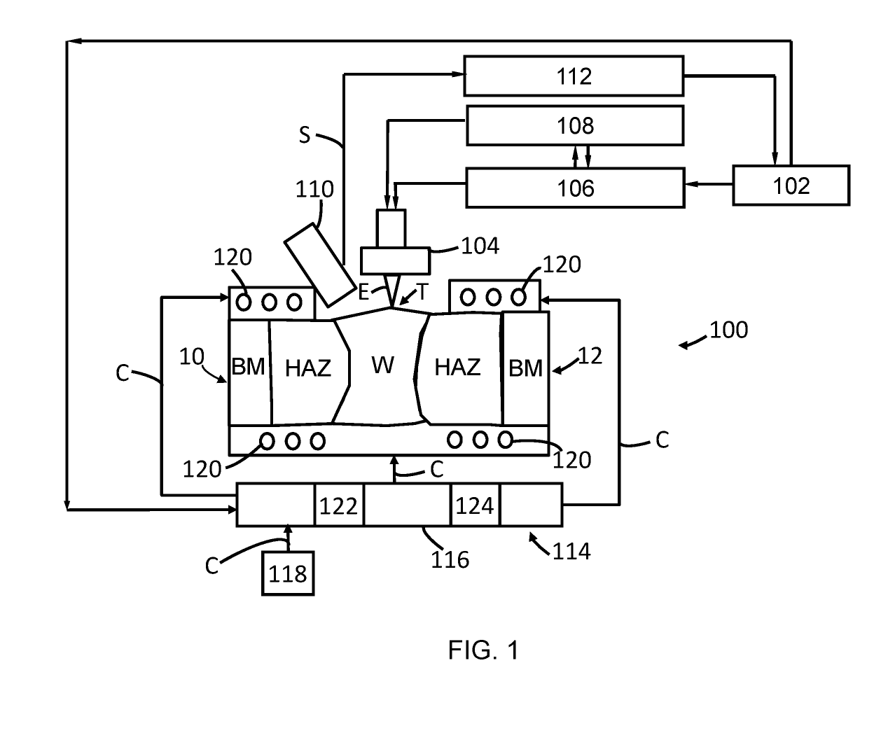

Referring now to the drawings, wherein the like numerals indicate corresponding parts throughout the several views, FIG. 1 schematically illustrates a welding system 100 in accordance with an embodiment of the present disclosure. The welding system 100 can be used to weld at least two workpieces 10, 12 of the same or different materials. The workpieces 10, 12 may be, for example, metal sheets. In the present disclosure, the workpiece 10 may be referred to as a first workpiece, and the workpiece 12 may be referred to as a second workpiece 12. The base material of the first and second workpieces 10, 12 may include at least one alloy. As non-limiting examples, the base material may be an iron-based alloy (e.g., as steel), an aluminum alloy, or magnesium. For example, the base material may be an advanced high-strength steel (AHSS). AHSSs are steels with a microstructure other than ferrite-pearlite (e.g., martensite, bainite, austenite, and/or retained austenite) in quantities sufficient to produce unique mechanical properties, such as a high strain hardening capacity and ultra-high yield and tensile strengths. AHSSs include, but are not limited to, dual phase (DP), transformation-induced plasticity (TRIP), complex phase (CP), and martensitic steels (MS) as well as press-hardened steel (PHS). DP steels include a ferritic matrix containing a hard martensitic second phase in the form of islands. CP steels include relatively small amounts of martensite, retained austenite and pearlite within the ferrite/bainite matrix. MS steels have a martensitic matrix containing small amounts of ferrite and/or bainite. The microstructure of TRIP steels is retained austenite embedded in a primary matrix of ferrite. AHSSs are named and marketed according to their metallurgical type (e.g., DP, TRIP, CP, etc.) and their strength in megapascal (MPa). For example, DP980 refers to a dual phase steel type with 980 MPa minimum yield strength. AHSSs may be used in vehicles, such as cars and trucks.

With continued reference to FIG. 1, the welding system 100 includes a control module 102. The terms “control module,” “module,” “control,” “controller,” “control unit,” “processor” and similar terms mean any one or various combinations of one or more of Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs or routines, combinational logic circuit(s), sequential logic circuit(s), input/output circuit(s) and devices, appropriate signal conditioning and buffer circuitry, and other components to provide the described functionality. “Software,” “firmware,” “programs,” “instructions,” “routines,” “code,” “algorithms” and similar terms mean any controller executable instruction sets. As a non-limiting example, the control module 102 may include at least one processor and associated memory. Regardless of its specific configuration, the control module 102 can control the overall operation of the welding system 100 based on instructions stored in an internal or external memory.

The welding system 100 further includes a welding head 104 and a robot control unit 106 for controlling the movement and operation of the welding head 104 in relation to the first and second workpieces 10, 12. The robot control unit 106 may be a computer numerical control (CNC) unit capable of controlling the movement and location of the welding head 104. To do so, the robot control unit 106 is mechanically coupled to the welding head 104 and in electronic communication with the control module 102. The robot control unit 106 can therefore receive input (i.e., instructions) from the control module 102 and can then stop or move the welding head 104 relative to the first and second workpieces 10, 12.

In addition to the robot control unit 106, the welding system 100 includes an energy source 108 configured to supply energy E (e.g., such as a gas flame, an electric arc, a laser, an electron beam, friction, or ultrasound). The energy source 108 is coupled to the welding head 104, and the welding head 104 can direct the energy E (e.g., gas flame, an electric arc, a laser, an electron beam, friction, or ultrasound) from the energy source 108 toward the first and second workpieces 10, 12. The robot control unit 106 is in electronic communication with the energy source 108 and can therefore activate or deactivate the energy source 108. Upon activation, the welding head 104 directs energy E from the energy source 108 to the first and second workpieces 10, 12. Upon deactivation, the welding head 104 stops directing energy E from the energy source 108 to the first and second workpieces 10, 12.

The welding system 100 further includes a data acquisition unit 112 and at least one temperature sensor 110 capable of detecting the temperature of the first and second workpieces 10, 12 and generating a temperature signal S indicative of the temperature of the first and second workpieces 10, 12 at and near the target location T. The temperature sensor 110 is in electronic communication with the data acquisition unit 112 and may be a pyrometer, a thermal camera, or a combination thereof. The temperature sensor 110 can also be a contact-type temperature sensor like thermocouple. The data acquisition unit 112 receives input (e.g., temperature signal S) from the temperature sensor 110 and stores data indicative of the temperature of the first and second workpieces 10, 12. Accordingly, the data acquisition unit 112 includes memory capable of storing data received from the temperature sensor 110. The control module 102 is in electronic communication with the data acquisition unit 112 and can receive data relative to the workpieces temperature from the data acquisition unit 112.

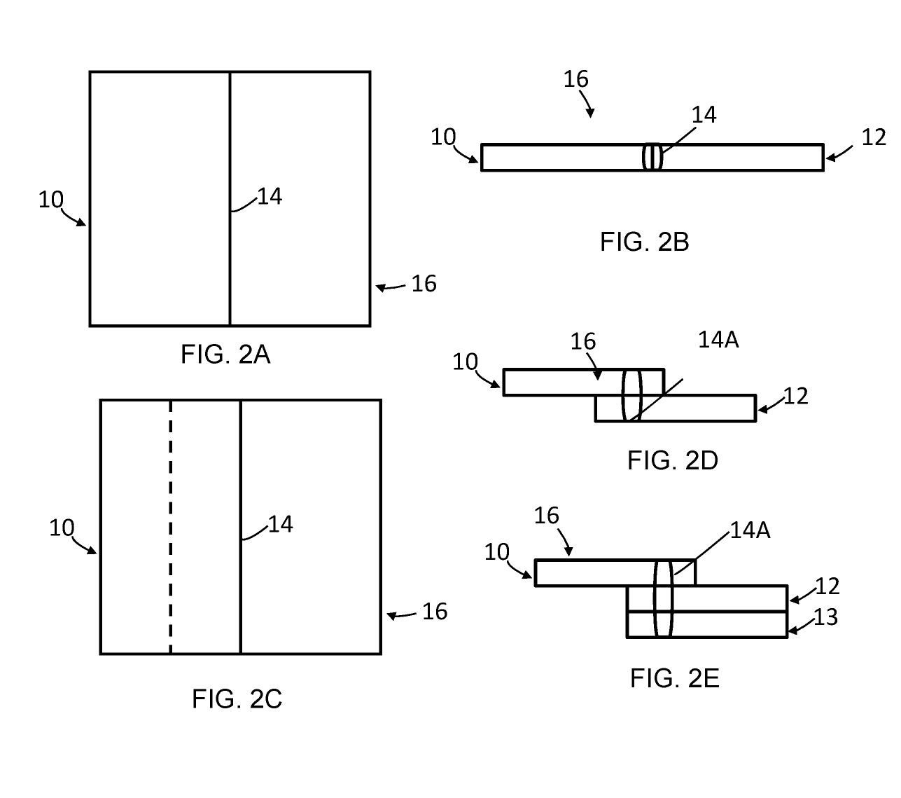

The welding system 100 can be used to weld the first and second workpieces 10, 12 together. To do so, the robot control unit 106 activates the energy source 108 once the welding head 104 has reached a target location T at an interference between the first and second workpieces 10, 12. Upon activation, the energy source 108 supplies energy E to the welding head 104, and the welding head 104 directs the energy E to the target location T, which is at an interference between the first and second workpieces 10, 12. The welding head 104 should supply sufficient energy E to the first and second workpieces 10, 12 to melt the base material of the first and second workpieces 10, 12 at the target location T. In order words, the energy E applied by the welding head 104 should be sufficient to generate enough heat to melt the base material of the first and second workpieces 10, 12 at the target location T. A filler material may be added into the molten pool (e.g., a location at an interference between the first and second workpieces 10, 12). The term “weld pool” refers to a pool of melted base material and may include melted filler material. The weld pool W then cools to form a weld 14 (FIG. 2A and 2B) that joins the first and second workpieces 10, 12 in order to form a welded joint 16 such as tailored welded blank or lap joint or fillet joint as well as T joint. FIG. 2A shows an example of a tailored welded blank. As seen in FIG. 2A, the welded joint 16 includes at least two workpieces 10, 12 that are welded together in both butt joint type and lap joint type. FIG. 2C and 2D show workpieces 10, 12 joined by a lap joint 14A. FIG. 2E shows three workpieces 10, 12, 13 joined together by a lap joint 14A.

With continued reference to FIG. 1, although not directly subjected to the energy E, the area of the first and second workpieces 10, 12 around the weld pool W is also affected by the heat and is therefore referred to as the heat-affected zone (HAZ). Specifically, the HAZ refers to an area of the first and second workpieces 10, 12 around the weld pool W in which the microstructure of the base material changes due to the heat generated by the energy E applied to the first and second workpieces 10, 12 at the target location T. As a consequence of the changes in its microstructure, the base material may soften at the HAZ. HAZ softening causes changes in the strength, hardness, ductility, and formability of the base material. For example, the hardness of HAZ may be lower than the hardness of the base material BM (after welding has been completed).

In order to minimize HAZ softening, the HAZs are cooled during or after the welding process. Also, cooling of the workpieces 10, 12 prior to welding reduces the HAZ softening. To do so, a cooling system 114 may be used to cool the HAZs during, after, or prior to the welding process. The cooling system 114 may be external or part of the welding system 100. Regardless, the cooling system 114 is in electronic communication with the control module 102 and includes a cooling controller 116 and passageways 120 for conveying a coolant C, such as water. The passageways 120 may be tubes, such as cooper tubes, or any other apparatus suitable to convey coolant C. The passageways 120 (e.g., cooper tubes) may be disposed adjacent the first and second workpieces 10, 12 such that coolant C flowing through the passageways 120 can cool the first and second workpieces 10, 12. The cooling controller 116 is fluidly coupled to a coolant source 118 and can therefore receive coolant C from the coolant source 118. For example, the coolant C may be any type of fluid (e.g., liquid or gas) and, therefore, the cooling controller 116 can receive a cold liquid (e.g., cold water) or a cold gas (e.g., chiller gas). In other words, the coolant source 118 is in fluid communication (e.g., liquid or gaseous communication) with the cooling system 114. The coolant source 118 contains coolant (e.g., water). The cooling controller 116 can control the temperature of the coolant C (i.e., the coolant or target temperature). To do so, the cooling controller 116 may include a cooling device 122, such as a chiller. The cooling device 122 removes heat from the coolant C, and the cooling controller 116 can supply coolant C to the passageways 120 at a controlled temperature. The cooling controller 116 can also control the flow rate of the coolant C (i.e., the coolant flow rate) delivered to the passageways 120. To do so, the cooling controller 116 may include at least one control valve 124 configured to control the flow rate of the coolant C. In addition to the flow rate, the cooling controller 116 can control the location of the cooling by, for example, allowing coolant C to flow through some of (but not all) the passageways 120. To do so, the cooling controller 116 may include additional valves (not shown) capable of controlling the flow of coolant C through the passageways 120.

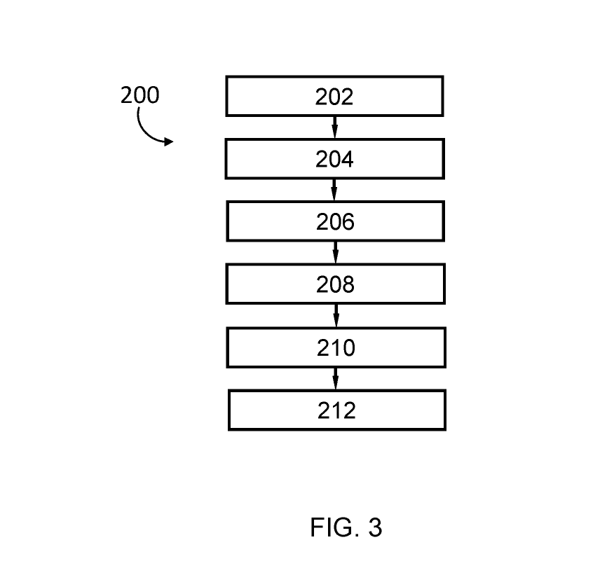

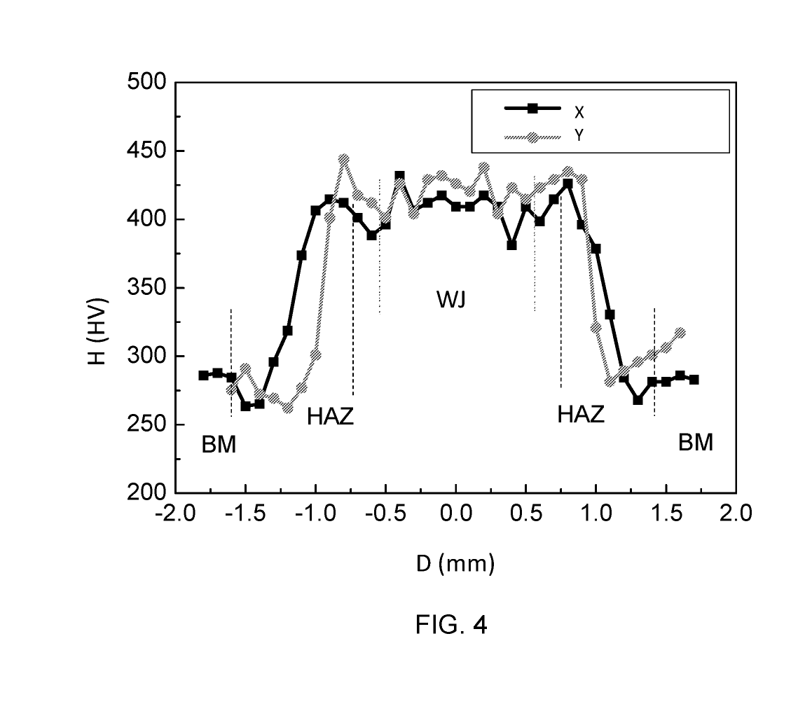

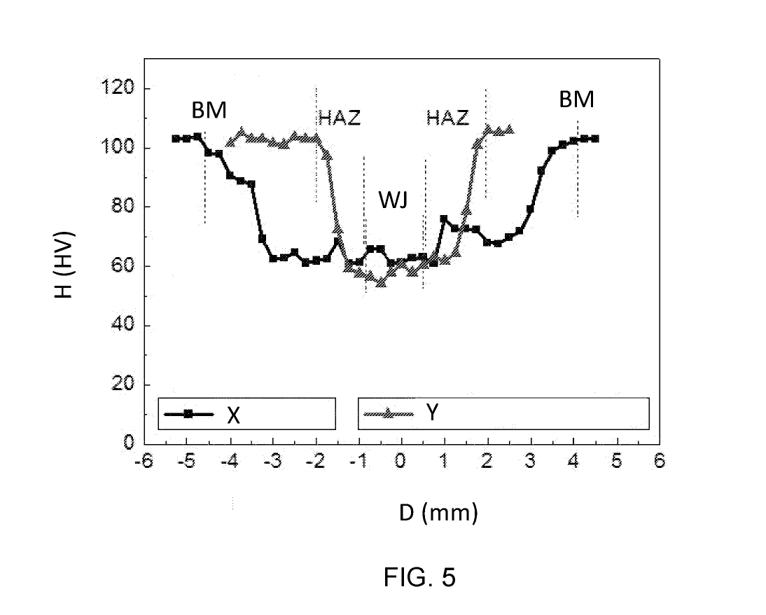

FIG. 3 illustrates a welding method 200 for joining at least two workpieces 10, 12 (FIG. 2A). In particular, the welding method 200 is capable of enhancing the mechanical properties of the weld joint 14 (FIG. 2A) by cooling the first and second workpieces 10, 12 in order to minimize HAZ softening. As discussed above, it is useful to minimize HAZ softening during the welding process in order to enhance the mechanical properties (e.g., strength, hardness, ductility, and formability) of the weld joints 14 (FIG. 2A). Experiments on DP980 steel subjected to laser welding have proven that cooling the HAZ of the workpieces 10, 12 using the presently disclosed welding method 200 results in weld joints 14 with increased strength and ductility in comparison with weld joints in which the HAZ are not cooled as set forth in the welding method 200. See Table A below. Additionally, the formability of the tailored welded blank produced using the welding method 200 improves in comparison to the formability of the tailored welded blanks produced using a welding process that does not include cooling the HAZs. See Table B below. Further, the hardness of the tailored welded blank produced using the welding method 200 improves in comparison to the hardness of the tailored welded blanks produced using a welding process that does not include cooling the HAZs. See graphs in FIGS. 4 and 5. In FIG. 4, HV stands for hardness in Vickers hardness scale, D stands for the distance from the weld centerline in millimeters, X stands for data points using conventional welding, Y stands for data points using the welding method 200, WJ stands for the weld joint, HAZ for the heat-affected zones, and BM for the base material around the HAZs. FIG. 5 is graph similar to the graph of FIG. 4, but it shows the results of hardness tests for 6061 aluminum alloy.

TABLE A

| | | Ultimate Tensile | Total |
|---|---|---|---|
| Samples | | Strength (MPa) | Elongation (%) |
| DP980 Base Material | | 1009 | 13.6 |
| DP980 butt joints | Without cooling | 952 | 5.6 |
| | With cooling | 1004 | 12.7 |

TABLE B

| | | | Limiting Dome |
|---|---|---|---|
| | Samples | | Height (mm) |
| DP980 Base Material | | | 27.54 |
| | DP980 butt joints | Without cooling | 10.49 |
| | | With cooling | 16.78 |

The welding method 200 begins at step 202. Step 202 entails determining a chemical composition of the first and second workpieces 10, 12. In particular, step 202 entails determining the chemical composition of the base material forming the first and second workpieces 10, 12. The first and second workpieces 10, 12 may have the same or different chemical compositions. The chemical composition of the first and second workpieces 10, 12 may be supplied by the vendor of the first and second workpieces 10, 12 and may already be stored in the memory of the control module 102 in, for example, a lookup table. In addition, chemical composition of the workpieces 10, 12 can also be determined by the other methods such as non-limiting methods of X-Ray Fluorescence(XRF) and DES. Accordingly, the control module 102 may determine the chemical composition of the first and second workpieces 10, 12 by retrieving the information from its memory.

The welding method 200 then proceeds to step 204. Step 204 entails determining, via the control module 102, the martensite tempering temperature of the first and second workpieces 10, 12 based, at least in part, on the chemical composition and microstructure of the first and second workpieces 10. 12. In particular, step 204 entails calculating, via the control module 102, the martensite tempering temperature of the base material forming the first and second workpieces 10, 12.

Next, the welding method 200 proceeds to step 206. Step 206 entails applying sufficient energy E to the first and second workpieces 10, 12 to melt the first and second workpieces 10, 12 at the target location T, thereby creating the weld pool W. As discussed above, the target location T is at an interference between the first and second workpieces 10, 12. Energy E (e.g., laser) may be applied to the first and second workpieces 10, 12 using the welding head 104, robot control unit 106, and energy source 108 as discussed above. Therefore, step 206 may also include positioning the welding head 104 at an interference between the first and second workpieces 10, 12 over the target location T and then activating the energy source 108 using the robot control unit 106 to apply energy E to the first and second workpieces 10, 12 at the target location T. Step 206 may further include adding a filler material to the base material at the target location T once the base material has reached its melting point. In other words, step 206 may include adding a filler material to the weld pool. Step 206 may be part of a fusion welding process. As non-limiting examples, the fusion welding process may be arc welding (e.g., tungsten inert gas (TIG) welding, plasma welding, gas tungsten arc welding (GTAW)), laser welding, resistance spot welding, solid state welding (e.g., friction stir welding), ultrasonic welding, or combination thereof, such as a hybrid laser-arc welding.

Next, the welding method 200 continues to step 208. Step 208 entails determining, via the control module 102, the temperature of the first and second workpieces 10, 12 (i.e., the measured temperature) in order to identify the locations of the heat-affected zones (HAZs) in the base material of the first and second workpieces 10, 12. To do so, the temperature sensor 110 may detect the temperature of the first and second workpieces 10, 12 at and around the target location T (FIG. 1). The temperature sensor 110 then generates a temperature signal S indicative of the temperature at different locations along the first and second workpieces 10, 12. The control module 102 receives, via the data acquisition unit 112, the temperature signal S. To identify the HAZs, the control module 102 may identify the areas of the first and second workpieces 10, 12 in which the temperature of the base material is equal to or greater than a temperature threshold. As non-limiting examples, the temperature threshold may have a lower critical temperature of a hypoeutectoid steel (Ac1) or the upper critical temperature (Ac3) of a hypoeutectoid steel. In this disclosure, the term “lower critical temperature of a hypoeutectoid steel (Ac1)” refers to a temperature at which, during heating, austenite starts to form. The term “upper critical temperature (Ac3) of a hypoeutectoid steel” refers to the temperature at which transformation of ferrite into austenite is completed upon heating. The control module 102 may determine that the HAZs of the base material are located in areas in which the measured temperature ranges between a lower temperature threshold and an upper temperature threshold. The lower temperature threshold may be the lower critical temperature (Ac1) or the martensite start temperature (Ms) of the base material. The upper temperature threshold may be the upper critical temperature (Ac3) or the melting point of the base material. The HAZs does not include areas of the base material where the base material melts during the welding process.

Then, the welding method 200 continues to step 210. Step 210 entails determining, via the control module 102, the cooling parameters suitable to cool the first and second workpieces 10, 12 until the temperature of the first and second workpieces at the HAZs is controlled below the martensite tempering temperature determined in step 204. Thus, step 210 entails determining, via the control module 102, the cooling parameters for the HAZs based, at least in part, on the martensite tempering temperature. The cooling parameters may include, but are not limited to, the target temperature and target flow rate of the coolant C flowing through the passageways 120 as well as the cooling location in the first and second workpieces 10, 12. The target temperature of the coolant C is also referred to as the coolant temperature, and the flow rate of the coolant C flowing through the passageways 120 is referred to as the coolant flow rate. Accordingly, step 210 includes determining, via the control module 102, the coolant temperature based, at least in part, on the martensite tempering temperature determined in step 204 and HAZ width. The “HAZ width” refers to the width of the HAZ. In addition, step 210 includes determining, via the control module 102, the coolant flow rate based, at least in part, on the martensite tempering temperature determined in step 204. Furthermore, step 210 includes determining, via the control module 102, the cooling location in the first and second workpieces 10, 12 based, at least in part, on the location of the HAZs identified in step 208. In the present disclosure, the “cooling location” refers to the areas in the first and second workpieces 10, 12 that should be cooled in order to minimize HAZ softening. The cooling parameters may also include a cooling range. The term “cooling range” means the difference in temperature between the cooling C entering the passageways 120 and the coolant C leaving the passageways 120. Step 210 also include determining the cooling range.

Next, the welding method 200 proceeds to step 212. Step 212 entails cooling the first and second workpieces 10, 12 (using the cooling system 114) such that the temperature of the first and second workpieces 10, 12 at the HAZs is controlled below the martensite tempering temperature in order to minimize softening at the HAZs. As discussed above, each HAZ is an area of the first and second workpieces 10, 12 around the weld pool W subjected to heat stemming from the energy E applied to the first and second workpieces 10, 12 at the target location T. To cool the first and second workpieces 10, 12, the cooling system 114 delivers coolant C (e.g., cold water) through the passageways 120 in order to cool the HAZs of the first and second workpieces 10, 12. In particular, the cooling system 114 supplies coolant C to the passageways 120 at the coolant temperature and coolant flow rate determined in step 210. Also, the cooling system 114 is configured to carry the coolant C and deliver the coolant C to the passageways 120 located adjacent to the cooling location determined in step 210. Accordingly, the cooling system 114 can cool mainly around the HAZs of the first and second workpieces 10, 12. It is also contemplated that the cooling system may cool only the HAZs of the first and second workpieces 10, 12. Step 212 (i.e., cooling) and step 206 (i.e., applying energy E) may be conducted simultaneously. Also, the step 212 (i.e., cooling) may be conducted before or after step 206 (i.e., applying energy E).

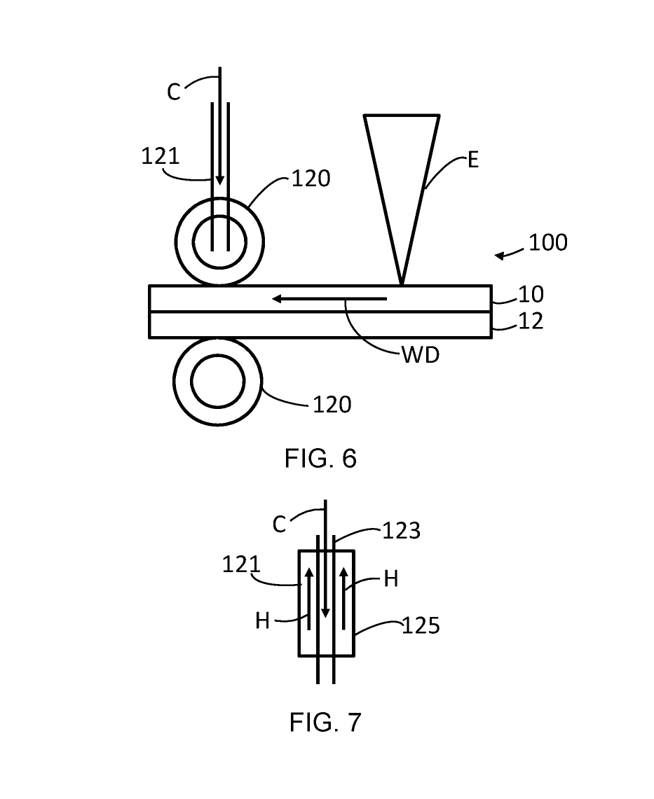

FIG. 6 shows another embodiment of the welding system 100. In this embodiment, the passageways 120, which may be tubes or clamping wheel, are used for cooling and clamping the workpieces 10, 12 together. The welding system 100 further includes at least one conduit 121 to deliver coolant C to the passageways 120. The welding direction WD of this embodiment is different from the other embodiments. As shown in FIG. 7, the conduit 121 includes a first area 123 to deliver the coolant A and a second area 125 to extract used coolant H (e.g., warm water).

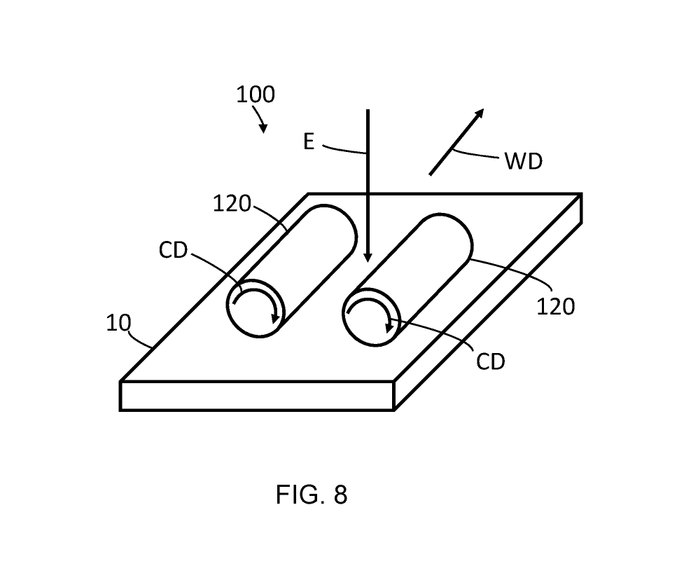

FIG. 8 shows another embodiment of the welding system 100. In this embodiment, the welding system 100 along the same welding direction WD. The energy E is applied between the passageways 120, which can be utilized for cooling and clamping. In this embodiment, element 120 is a wheel and coolant is passed along the conduit inside the wheel. The energy is set between two wheels. The wheels move in the same direction as the welding direction WD.

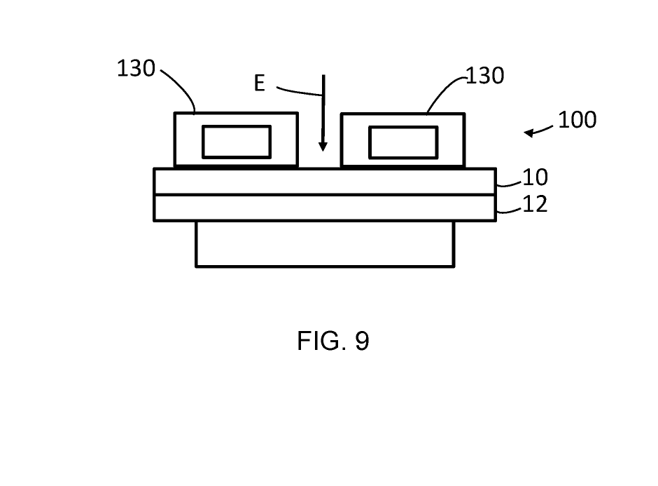

FIG. 9 shows another embodiment of the welding system 100. In this embodiment, the welding system 100 includes a phase clamping mechanism 130 for clamping the workpieces 10, 12. The phase claiming mechanism can also carry coolant in order to cool the HAZ. The welding system 100 may include phase change materials in the clamping. The phase change materials can also carry heat away to cool the HAZ. In addition, phase change materials can be inserted any clamping around the HAZ to cool HAZ.

While the best modes for carrying out the invention have been described in detail, those familiar with the art to which this invention relates will recognize various alternative designs and embodiments for practicing the invention within the scope of the appended claims.

1. A welding method, comprising:
determining, via a control module, a martensite tempering temperature of at least two workpieces based, at least in part, on a chemical composition of the at least two workpieces;
applying sufficient energy to the at least two workpieces to melt the at least two workpieces at a target location, thereby creating a weld pool, the target location being located at an interference between the at least two workpieces;
determining, via the control module, a target temperature of a coolant based, at least in part, on the martensite tempering temperature the at least two workpieces; and
cooling the at least two workpieces with the coolant such that a temperature of the at least two workpieces at heat-affected zones is controlled below the martensite tempering temperature in order to minimize softening at the heat-affected zones, wherein each heat-affected zone is an area of the at least two workpieces around the weld pool subjected to heat stemming from the energy applied to the at least two workpieces at the target location.

2. The welding method of claim 1, wherein cooling the at least two workpieces and applying sufficient energy to the at least two workpieces are conducted simultaneously.

3. The welding method of claim 1, wherein cooling the at least two workpieces is conducted after applying sufficient energy to the at least two workpieces.

4. The welding method of claim 1, wherein cooling the at least two workpieces is conducted before applying sufficient energy to the at least two workpieces.

5. The welding method of claim 1, wherein the cooling is conducted using a cooling system that includes passageways configured to convey the coolant.

6. The welding method of claim 1, further comprising determining a flow rate of the coolant flowing through the passageways based, at least in part, on the martensite tempering temperature.

7. The welding method of claim 6, further comprising determining a cooling location based, at least in part, on a location of the heat-affected zones in the at least two workpieces, wherein the cooling location is an area in the at least two workpieces in need of cooling in order to minimize softening in the heat-affected zones.

8. The welding method of claim 7, wherein cooling the at least two workpieces includes cooling mainly the heat-affected zones of the at least two workpieces.

9. The welding method of claim 8, further comprising determining a temperature of the at least two workpieces in order to identify the location of the heat-affected zones in the at least two workpieces.

10. The welding method of claim 1, wherein at least one of the at least two workpieces is made of aluminum alloy.

11. The welding method of claim 1, wherein applying sufficient energy is part of a fusion welding process selected from the group consisting of arc welding, laser welding, resistance spot welding, solid state welding, ultrasonic welding, and a combination thereof.

12. The welding method of claim 1, wherein applying sufficient energy is part of a friction stir welding process.

13. The welding method of claim 1, wherein applying sufficient energy is part of a hybrid laser-arc welding process.

14. The welding method of claim 1, further comprising addition a filler material to the weld pool.

15. A welding system, comprising:
an energy source configured to supply energy;
a welding head coupled to the energy source and configured to direct sufficient energy to at least two workpieces to melt the at least two workpieces at a target location in order to create a weld pool, the target location being located at an interference between the at least two workpieces;
a control module programmed to:
determine a martensite tempering temperature of the at least two workpieces based, at least in part, on a chemical composition of the at least two workpieces;
determine a temperature of a coolant based, at least in part, on the martensite tempering temperature; and
a cooling system configured to carry the coolant to cool the at least two workpieces such that a temperature of the at least two workpieces at heat-affected zones is controlled below the martensite tempering temperature in order to minimize softening at the heat-affected zones, wherein each heat-affected zone is an area of the at least two workpieces around the weld pool subjected to heat stemming from the energy applied to the at least two workpieces at the target location.

16. The welding system of claim 15, wherein the cooling system is configured to cool the at least two workpieces while the welding head directs the energy from the energy source to the at least two workpieces.

17. The welding system of claim 15, wherein the cooling system has passageways configured to convey a coolant.

18. The welding system of claim 17, wherein the control module is configured to determine a flow rate of the coolant flowing through the passageways based, at least in part, on the martensite tempering temperature.

19. The welding system of claim 18, wherein the cooling system includes a control valve configured to control the flow rate of the coolant.

20. The welding system of claim 18, wherein the control module is configured to determine a cooling location based, at least in part, on a location of the heat-affected zones in the at least two workpieces, wherein the cooling location is an area in the at least two workpieces in need of cooling in order to minimize softening in the heat-affected zones.
